(19) United States
(12) Patent Application Publication
(10) Pub. No.: US 2012/0160257 A1
(43) Pub. Date: Jun. 28, 2012

(54) EXFOLIATING BATH AND SHOWER GLOVE

(76) Inventor: Michelle Poteat Jenkins, Rock Hill, SC (US)

(21) Appl. No.: 13/337,141

(22) Filed: Dec. 25, 2011

Related U.S. Application Data
(60) Provisional application No. 61/427,451, filed on Dec. 27, 2010.

(51) Int. Cl. A47K 7/02; B08B 1/00; A41D 19/00

(52) U.S. Cl. 132/200; 2/160

(57) ABSTRACT

A glove for use in the bath or shower can include a palm front section, a palm back section, five separate finger sections, a wrist section defining an opening for receiving a user's hand, and a multi-layered ruffled inset attached to at least one section of the glove. The ruffled inset can be attached to the palm front section of the glove by stitching, adhesive, and/or hook and loop fasteners. The glove can be made of elastic material, and the ruffled inset can be an exfoliating sponge.

This application claims priority to U.S. Application No. 61/427,451, filed Dec. 27, 2010, and which is incorporated herein. The present invention relates to a glove for use in the bath or shower.

### TECHNICAL FIELD AND BACKGROUND OF THE INVENTION

Various bath towels bath mitts, bath gloves and bath sponges are known in the art. Each of these items serves a different purpose for essentially the same function for the user, which is to aid in the cleansing of the body.

The bath towel is a loose piece of cloth that the user can use with solid or liquid forms of soap to cleanse the body. A disadvantage of the bath towel is that it can ball up and slip out of the hand easily plus it cannot maintain a continuous flow of foam or suds without repeat uses of the soap.

The bath mitt is a glove that encases the user's thumb separately and the other four fingers together. This mitt-type design fits over the hand which prevents the glove from slipping out of the hand like a common bath towel. However, a disadvantage of the bath mitt is that it does not allow for full function of the four fingers opposed to the thumb, so users cannot fully grip bars of soap. Also, the mitt does not provide a continuous flow of foam or suds without the repeat handling and usage of the soap.

The bath glove is similar to the bath mitt except it gives full functionality of all fingers. With this format the fingers are able to fully grip solid soap or to massage liquid soap. This style also allows the user to fully wipe the body and its contours. However, a disadvantage of the bath glove is that it does not provide a continuous flow of foam or suds without the repeated handling and usage of the soap.

The bath sponge is made out of elastic netting that is formed into a multi-layered, ruffled, ball with a string attached. The ruffled layers of the ball allow for the capture of more soap bubbles and a more continuous flow of foam or suds with fewer usages and handling of the soap. A disadvantage of the bath sponge is that it is not as functional as a bath glove, and cannot be maneuvered as well in the more intimate areas and contours of the body.

In view of the above mentioned disadvantages existing in the conventional bath towel, bath mitt, bath glove and bath sponge, the present invention provides an improved bath and shower glove. The present invention provides a bath and shower glove overcoming the disadvantages of the aforementioned conventional products, and provides a product that can thoroughly clean the user's skin with less amounts of body cleansing foam or soap as is needed in the aforementioned conventional products.

### SUMMARY OF OBJECTS AND EMBODIMENTS OF THE INVENTION

Therefore, one object of the present invention is to provide an improved bath and shower glove which fits securely over the user's hand and allows for full functionality of every individual finger.

Another object of the present invention is to provide a ruffled layer of material on the inset of the glove, which allows the user to clean the body more thoroughly by holding the cleansing gel, foam or soap and catching more and providing finer bubbles/foam among the ruffled layers.

Another object of the present invention is to provide a secure fit on the hand to prevent it from accidently dropping off the user's hand.

Another object of the present invention is to allow for full functionality of the user's hand and fingers, providing the ability to wash all contours, folds and hard to reach places.

Another object of the invention is to provide a continuous flow of foam and suds, and reduce waste of cleansing gel, foam and/or soap.

These and other objects of the present invention can be achieved in the preferred embodiments of the invention described below, in which one embodiment comprises an apparatus for use in bathing or showering comprising a glove having a palm front section, a palm back section, five separate finger sections, a wrist section defining an opening for receiving a user's hand, and a multi-layered ruffled inset attached to at least one section of the glove.

According to another embodiment of the invention, the five separate finger sections are comprised of a first section for receiving the user's thumb, and second, third, fourth and fifth sections for receiving the user's four fingers opposed to the thumb.

According to another embodiment of the invention, the ruffled inset is attached to the palm front section of the glove.

According to another embodiment of the invention, the ruffled inset is attached to the palm front section, and at least one of the finger sections.

According to another embodiment of the invention, the ruffled inset is stitched to the palm front section and the five finger sections.

According to another embodiment of the invention, the ruffled inset is attached to the palm front section of the glove by stitching, adhesive, and/or hook and loop fasteners.

According to another embodiment of the invention, the ruffled inset can be a sponge.

According to another embodiment of the invention, the ruffled inset can be made of a material having an exfoliating properties on human skin.

According to another embodiment of the invention, the ruffled inset can be made from nylon, polyethylene, plastic and/or polyester.

According to another embodiment of the invention, the palm front section, palm back section, and five finger sections and wrist section can be made of an elastic material.

According to another embodiment of the invention, a plurality of hook fasteners are positioned on the palm front section, and a plurality of loop fasteners are positioned on the ruffled inset for complementary engagement with the hook fasteners, so that the ruffled inset is removably attached to the palm front section.

According to another embodiment of the invention, a plurality of loop fasteners are positioned on the palm front section, and a plurality of hook fasteners are positioned on the ruffled inset for complementary engagement with the loop fasteners, so that the ruffled inset is removably attached to the palm front section.

According to another embodiment of the invention, a first section of hook fasteners is positioned on the palm front section, and a second section of hook fasteners is positioned on a front face of at least one of the finger sections. A first section of loop fasteners is positioned on the ruffled inset for complementary engagement with the first section of hook fasteners, and a second section of loop fasteners is positioned on the ruffled inset for complementary engagement with the second section of hook fasteners, so that the ruffled inset is removably attached to the palm front section.

According to another embodiment of the invention, a first section of loop fasteners is positioned on the palm front section, and a second section of loop fasteners positioned on a front face of at least one of the finger sections. A first section of hook fasteners is positioned on the ruffled inset for complementary engagement with the first section of hook fasteners, and a second section of hook fasteners is positioned on the ruffled inset for complementary engagement with the second section of hook fasteners, such that the ruffled inset is removably attached to the palm front section.

According to another embodiment of the invention, a rope is attached to the wrist section for hanging the glove.

According to another embodiment of the invention, a bath and shower glove comprises a palm front section, a palm back section, five separate finger sections, and a wrist section defining an opening for receiving a hand of a user. An exfoliating sponge is attached to the palm front section and/or one or more of the finger sections.

According to another embodiment of the invention, the exfoliating sponge is attached to the palm front section and/or one or more of the finger sections by stitching, adhesive, and/or hook and loop fasteners.

According to another embodiment of the invention, the exfoliating sponge is attached to the palm front section and the five finger sections.

According to another embodiment of the invention, a method of cleaning a person's body includes providing a bath and shower glove comprising a palm front section, a palm back section, five separate finger sections, and a wrist section defining an opening for receiving a hand of a user, and a multi-layered ruffled inset removably attached to the palm front section of the glove. The user's hand is positioned in the glove. The ruffled inset is wetted, and soap is placed in the ruffled inset. The ruffled inset is applied to a desired area of the body.

According to another embodiment of the invention, the ruffled inset can be detached from the palm front section of the glove when worn out and washed or replaced with another ruffled inset.

### BRIEF DESCRIPTION OF THE DRAWINGS

FIG. 1 is a front elevation of a bath and shower glove according to a preferred embodiment of the invention;

FIG. 2 is a back elevation view of the bath and shower glove of FIG. 1;

FIG. 3 is a side perspective view of the bath and shower glove of FIG. 1;

FIG. 4 is another side perspective view of the bath and shower glove of FIG. 1;

FIG. 4A is an enlarged partial view of the bath and shower glove of FIG. 1;

FIG. 5 is a bottom plan view of the bath and shower glove of FIG. 1;

FIG. 6 is an environmental perspective view illustrating a method of using the bath and shower glove of FIGS. 1; and

FIG. 7 is a perspective view of a bath and shower glove according to another preferred embodiment of the invention.

### DESCRIPTION OF THE PREFERRED EMBODIMENTS OF THE INVENTION AND BEST MODE

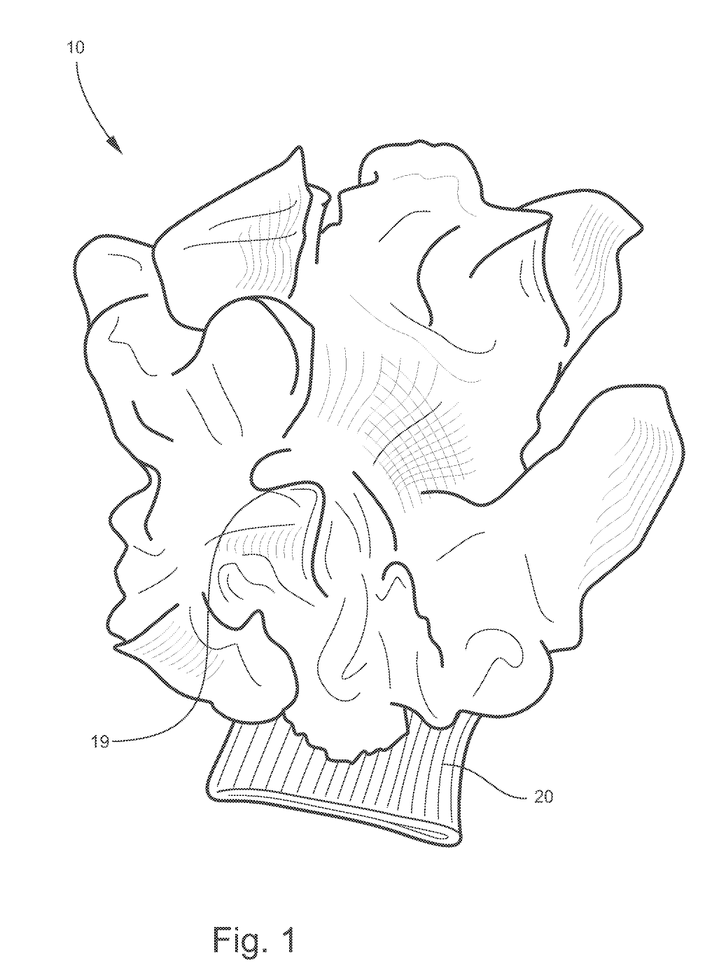

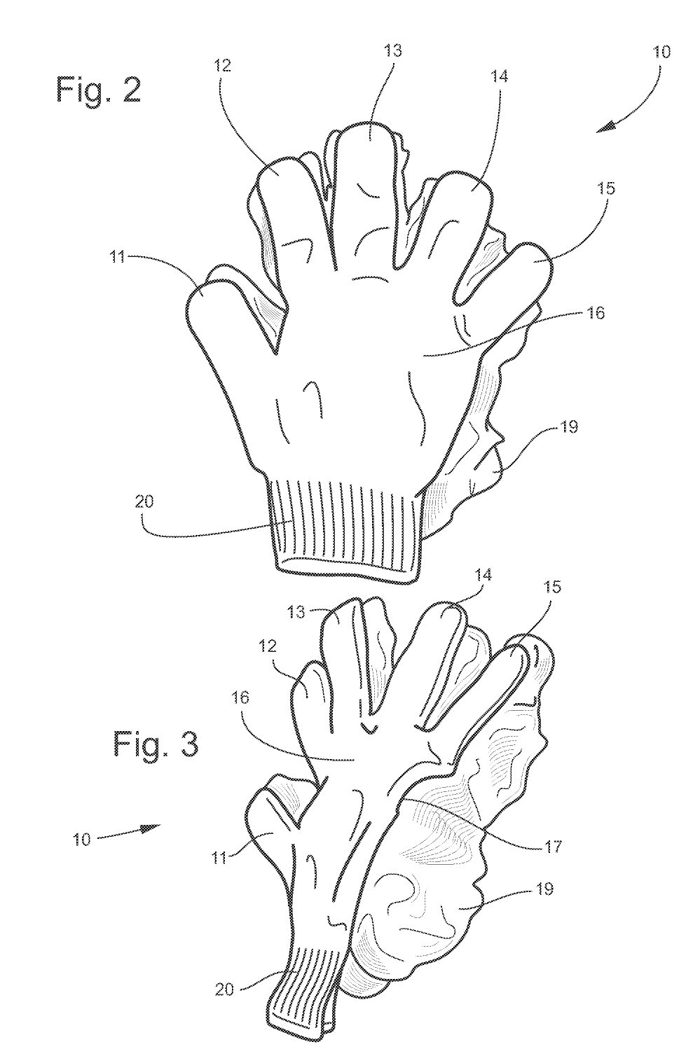

A bath and shower glove according to a preferred embodiment of the invention is illustrated in FIGS. 1-6, and shown generally at reference numeral 10. As shown in FIGS. 1 and 2, the glove 10 comprises a palm front 17, a palm back 16, a thumb section 11, four separate finger sections 12, 13, 14, 15, and an elastic wrist section 20. As shown in FIGS. 1, 3 and 4, a multi-layered ruffled inset 19 is attached to the palm front 17, thumb section 11 and finger sections 12-15. Alternatively, the ruffled inset 19 can be attached to the palm front 17 only. While the drawings show the glove 10 fitting on the right hand of a user, it is to be understood that the glove 10 can also be configured to fit on the left hand.

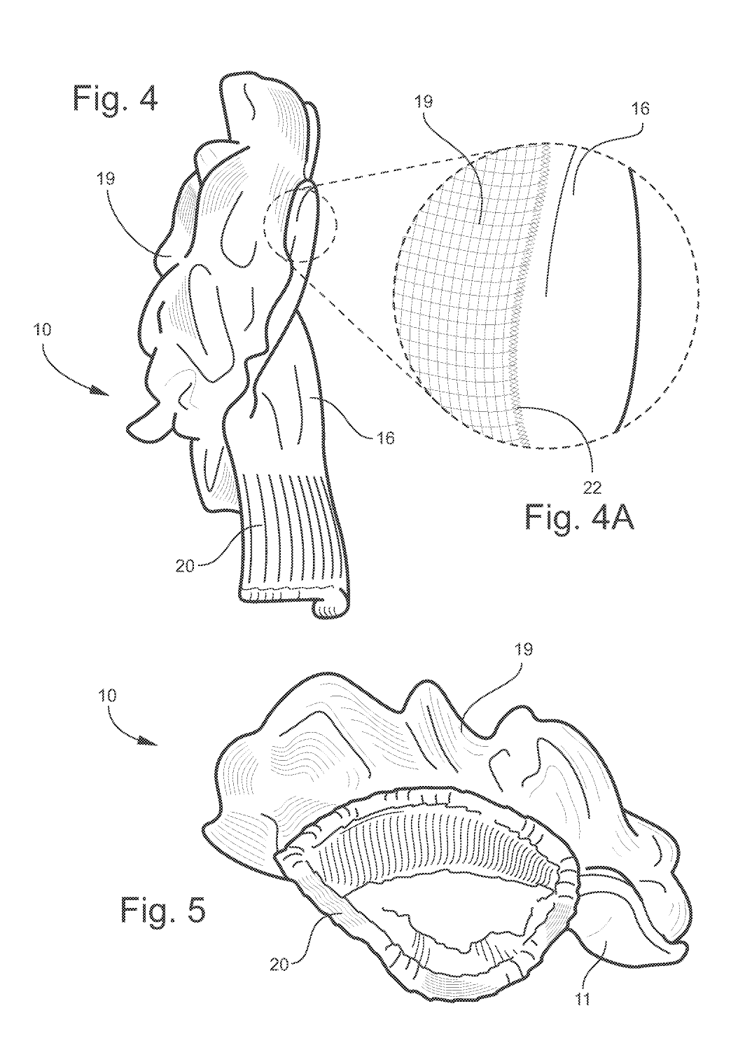

The glove 10 is made of a stretchable material, such as nylon, polyethylene and/or polyester. The glove 10 can be made of an exfoliating mesh material. The ruffled inset 19 comprises a sponge made from an exfoliating material, such as a plastic or nylon mesh. The ruffled inset 19 can be attached to the palm front 17, thumb section 11 and finger sections 12-15 by stitching 22, as shown in FIG. 4A, or other suitable attachment means, such as an adhesive.

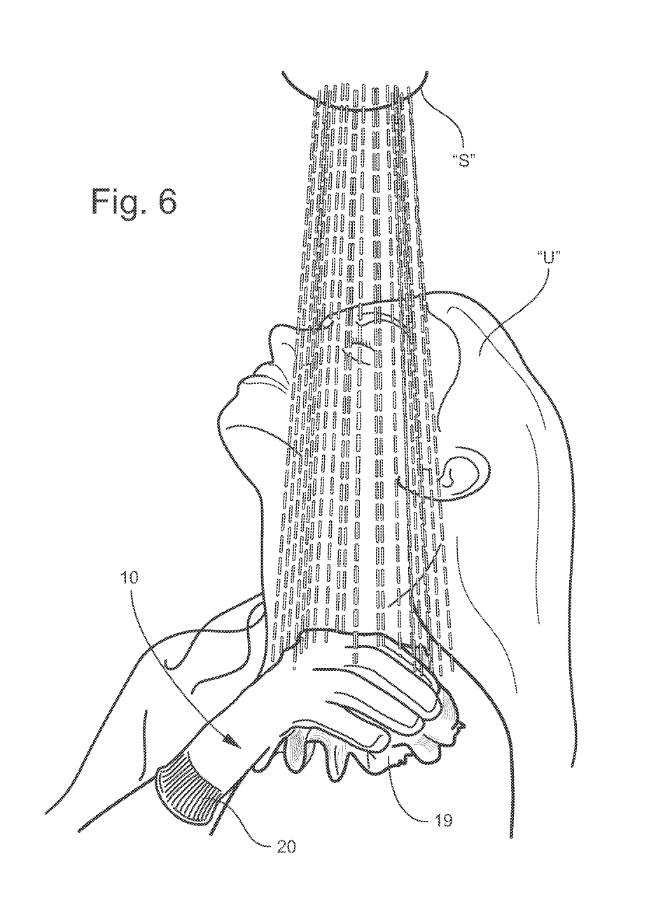

In a preferred method of using the glove 10, the glove 10 is worn on the hand of a user. The user then wets the ruffled inset 19, and places a solid or liquid soap form of soap in the ruffled inset 19 of the palm 17, and begins rubbing until the preferred amount of foam/bubbles have been achieved. The user applies the ruffled inset 19 to the desired area of the body, as shown in FIG. 6.

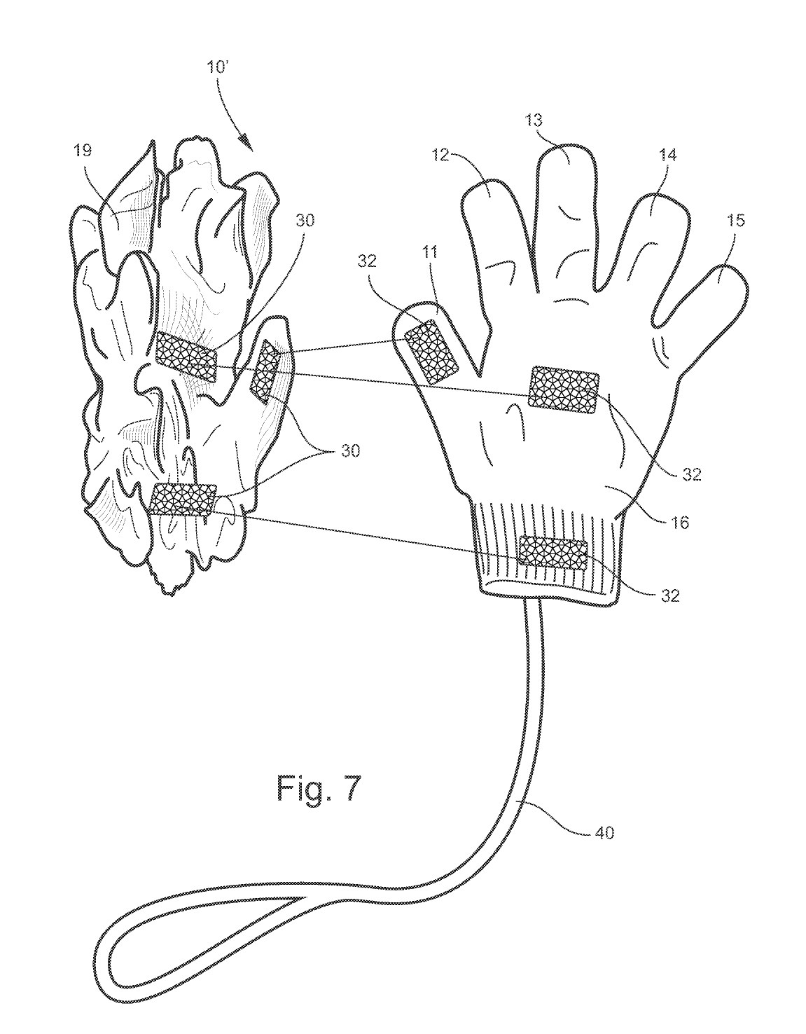

An alternative embodiment of the invention is illustrated in FIG. 7, and shown generally at reference numeral 10′. As shown in FIG. 7, the ruffled inset 19 can be removably attached to the palm front 17, thumb section 11 and finger sections 12-15 by sections of complementary hook and loop fasteners 30, 32 attached to the inset 19, and the palm front 17, thumb section 11, and finger sections 12-15. Loop fasteners 30 can be attached to the inset 19 while sections of hook fasteners 32 are attached to the palm front 17, thumb section 11, and finger sections 12-15, or vice versa. As such, the ruffled inset 19 can be easily removed when desired for cleaning such as in a washing machine or dishwasher, or can be discarded when worn out and replaced with a new inset. This feature is particularly beneficial in view of the fact that the inset 19 is likely to wear out prior to the other parts of the glove 10′. In addition, a rope 40 can be attached to the wrist section 20 of the glove 10′ so that the glove 10′ can be hung from a shower head or similar object.

A bath and shower glove and a method of using same are described above. Various changes can be made to the invention without departing from its scope. The above description of the preferred embodiments and best mode of the invention are provided for the purpose of illustration only and not limitation—the invention being defined by the following claims and equivalents thereof.

What is claimed is:

1. An apparatus for use in bathing or showering comprising:
(a) a glove comprising a palm front section, a palm back section, five separate finger sections, and a wrist section defining an opening for receiving a hand of a user; and
(b) a multi-layered ruffled inset attached to at least one section of the glove.

2. An apparatus according to claim 1, wherein the five separate finger sections comprise a first section for receiving the user's thumb, and second, third, fourth and fifth sections for receiving the user's four fingers opposed to the thumb.

3. An apparatus according to claim 1, wherein the ruffled inset is attached to the palm front section of the glove.

4. An apparatus according to claim 1, wherein the ruffled inset is attached to the palm front section, and at least one of the finger sections.

5. An apparatus according to claim 1, wherein the ruffled inset is stitched to the palm front section and the five finger sections.

6. An apparatus according to claim 1, further comprising attachment means for attaching the ruffled inset to the palm front section of the glove, wherein the attachment means is selected from the group consisting of stitching, adhesive, and hook and loop fasteners.

7. An apparatus according to claim 1, wherein the ruffled inset comprises a sponge.

8. An apparatus according to claim 1, wherein the ruffled inset comprises a material having an exfoliating properties on human skin.

9. An apparatus according to claim 1, wherein the ruffled inset is made from material selected from the group consisting of nylon, polyethylene, plastic and polyester.

10. An apparatus according to claim 1, wherein the palm front section, palm back section, and five finger sections and wrist section are comprised of an elastic material.

11. An apparatus according to claim 1, further comprising a plurality of hook fasteners positioned on the palm front section, and a plurality of loop fasteners positioned on the ruffled inset for complementary engagement with the hook fasteners, whereby the ruffled inset is removably attached to the palm front section.

12. An apparatus according to claim 1, further comprising a plurality of loop fasteners positioned on the palm front section, and a plurality of hook fasteners positioned on the ruffled inset for complementary engagement with the loop fasteners, whereby the ruffled inset is removably attached to the palm front section.

13. An apparatus according to claim 1, further comprising:
(a) a first section of hook fasteners positioned on the palm front section,
(b) a second section of hook fasteners positioned on a front face of at least one of the finger sections;
(c) a first section of loop fasteners positioned on the ruffled inset for complementary engagement with the first section of hook fasteners; and
(d) a second section of loop fasteners positioned on the ruffled inset for complementary engagement with the second section of hook fasteners, whereby the ruffled inset is removably attached to the palm front section.

14. An apparatus according to claim 1, further comprising:
(a) a first section of loop fasteners positioned on the palm front section,
(b) a second section of loop fasteners positioned on a front face of at least one of the finger sections;
(c) a first section of hook fasteners positioned on the ruffled inset for complementary engagement with the first section of hook fasteners; and
(d) a second section of hook fasteners positioned on the ruffled inset for complementary engagement with the second section of hook fasteners,
whereby the ruffled inset is removably attached to the palm front section.

15. An apparatus according to claim 1, further comprising a rope attached to the wrist section.

16. A bath and shower glove comprising:
(a) a palm front section, a palm back section, five separate finger sections, and a wrist section defining an opening for receiving a hand of a user;
(b) an exfoliating sponge; and
(c) attachment means for attaching the exfoliating sponge to at least one of the palm front section and the finger sections.

17. A glove according to claim 16, wherein the attachment means comprises at least one selected from the group consisting of stitching, adhesive, and hook and loop fasteners.

18. A glove according to claim 16, wherein the exfoliating sponge is attached to the palm front section and the five finger sections.

19. A method of cleaning a person's body comprising the steps of:
(a) providing a bath and shower glove comprising a palm front section, a palm back section, five separate finger sections, and a wrist section defining an opening for receiving a hand of a user, and a multi-layered ruffled inset removably attached to the palm front section of the glove;
(b) positioning a user's hand in the glove;
(c) wetting the ruffled inset;
(d) placing soap in the ruffled inset; and
(e) applying the ruffled inset to a desired area of the body.

20. A method according to claim 19, further comprising the step of detaching the ruffled inset from the palm front section of the glove when the inset has worn out.
